(19) United States
(12) Patent Application Publication
(10) Pub. No.: US 2024/0311617 A1
(43) Pub. Date: Sep. 19, 2024

(54) CONTROLLING AGENTS USING SUB-GOALS GENERATED BY LANGUAGE MODEL NEURAL NETWORKS

(71) Applicant: DeepMind Technologies Limited, London (GB)

(72) Inventors: Norman Di Palo, London (GB); Arunkumar Byravan, London (GB); Nicolas Manfred Otto Heess, London (GB); Martin Riedmiller, Balgheim (DE); Leonard Hasenclever, London (GB); Markus Wulfmeier, London (GB)

(21) Appl. No.: 18/443,285

(22) Filed: Feb. 15, 2024

Related U.S. Application Data
(60) Provisional application No. 63/445,999, filed on Feb. 15, 2023.

(51) Int. Cl. G06N 3/0455

(52) U.S. Cl. CPC G06N 3/0455

(57) ABSTRACT

Methods, systems, and apparatus, including computer programs encoded on a computer storage medium, for controlling agents using a language model neural network and a vision-language model (VLM) neural network.

### CROSS-REFREENCE TO RELATED APPLICATIONS

This application claims priority to U.S. Provisional Application No. 63/445,999, filed on Feb. 15, 2023. The disclosure of the prior application is considered part of and is incorporated by reference in the disclosure of this application.

### BACKGROUND

This specification relates to processing data using machine learning models.

Machine learning models receive an input and generate an output, e.g., a predicted output, based on the received input. Some machine learning models are parametric models and generate the output based on the received input and on values of the parameters of the model.

### SUMMARY

This specification generally describes a system implemented as computer programs on one or more computers in one or more locations that uses a language model neural network to (i) control an agent interacting with an environment to perform a task in the environment or (ii) assist an agent interacting with an environment to perform a task in the environment.

Particular embodiments of the subject matter described in this specification can be implemented so as to realize one or more of the following advantages.

This specification generally describes techniques for using a language model neural network and a vision-language model (VLM) neural network to improve the interaction of an agent with an environment, e.g., to improve the control of a robot interacting with a real-world environment to perform a task.

In particular, this specification describes using the language model neural network to partition a task into a sequence of sub-goals and then using the VLM neural network to determine when each of the sub-goals are achieved. This allows the agent to more effectively complete complicated real-world tasks, even when task rewards for the tasks are sparse. For example, this can allow the system to condition a policy neural network that is used to control the agent on a description of the current sub-goal, i.e., the latest sub-goal that has not yet been achieved, rather than needing to condition the policy neural network on a description of the overall task throughout the episode.

Moreover, the system can achieve this improvement without needing to re-train the language model neural network and therefore does not need to have access to any known decomposition or partition of tasks during training or at inference time, greatly increasing the range of tasks to which the described techniques can be applied.

Additionally, by making use of the VLM to determine when a given sub-goal is satisfied, the system can effectively switch to controlling or assisting the agent using the next sub-goal during a task episode without needing to receive any explicit signal from the environment that the sub-goal has been completed.

This specification also describes how the VLM and the language model neural network can be used to improve the training of a language-conditioned policy neural network that is used to control an agent.

In particular, the VLM and the language model neural network can be used to generate training data that provides a better learning signal for the policy neural network, thereby improving the performance of the policy neural network after training.

For example, the VLM and the language model neural network can be used to identify sub-goals that were effectively completed during a given trajectory (even if the corresponding larger task was not successfully achieved) and to add sub-trajectories corresponding to the sub-goals to a replay memory storing training data for use in training the policy neural network. By training on these sub-trajectories, the policy neural network can be trained to achieve sub-goals that are relevant to performing larger tasks in the environment.

As another example, the VLM and the language model neural network can be used to identify successful sub-trajectories in training data that has already been generated prior to training of the policy neural network on a current set of tasks. This allows a training system to leverage training data that was already generated for other tasks without requiring any additional control of the agent, speeding up learning by “bootstrapping” the set of available training data for the current set of tasks.

In one aspect, there is provided a method for generating instructions for an agent interacting with an environment to perform a task. The method comprises: receiving a natural language description of the task to be performed by the agent; and processing, using a language model neural network, an input sequence derived from the natural language description of the task to generate an output text sequence that comprises natural language descriptions of each of a sequence of sub-goals to be achieved by the agent while performing the task. The method further comprises, at each of one or more time steps: receiving a current observation image characterizing a current state of the environment at the time step; identifying a current sub-goal in the sequence of sub-goals being performed by the agent at the time step; generating, using the VLM neural network and from the current observation image, an observation embedding of the current observation; determining, whether the agent has successfully achieved the current sub-goal in the sequence as of the time step; and in response to determining that the agent has successfully achieved the current sub-goal in the sequence as of the time step, instructing the agent to perform a next sub-goal that follows the current sub-goal in the sequence.

In some implementations, the agent is a mechanical agent (such as a robot) and the environment is a real-world environment. The current observation image can comprise monochrome or color pixels of an image, which may be a 2D or 3D image. As defined herein an “image” includes a point cloud e.g., from a LIDAR system, and a “pixel” includes a point of the point cloud.

In general, the sequence of sub-goals (which may also be referred to as sub-tasks) comprises a plurality of sub-goals, e.g. two or more sub-goals.

Determining, from the observation embedding of the current observation and the text embedding of the current sub-goal, whether the agent has successfully achieved the current sub-goal in the sequence as of the time step may, for example, comprise: computing a similarity score between the observation embedding of the current observation and a text embedding of the current sub-goal; and determining that the agent has successfully achieved the current sub-goal when the similarity score satisfies a threshold (i.e. satisfies a criterion that depends on the threshold, e.g. the similarity score exceeds the threshold).

As used herein an embedding or representation refers to an ordered collection of numerical values, e.g., a vector, matrix, or other tensor of numerical values. The similarity score can, for example, comprise a dot product, i.e. a dot product between the observation embedding of the current observation and the text embedding of the current sub-goal.

The current sub-goal may initially be the first of the sub-goals in the sequence and the method may comprise instructing the agent to perform the first of the sub-goals. Instructing the agent to perform a sub-goal (such as the first sub-goal) may, for example, comprise determining, from the natural language description of the sub-goal, one or more actions to be performed by the agent and causing the agent to perform the one or more actions. In some implementations, this is achieved by processing an input comprising (i) data characterizing the current state of the environment and (ii) data representing the natural language description of the next sub-goal using a language-conditioned policy neural network to generate a policy output that defines an action to be performed by the agent; and selecting an action using the policy output.

In general, a language-conditioned policy neural network is a policy neural network that is conditioned on both text and data characterizing the state of the environment (e.g., sensor data from one or more sensors). That is, a language-conditioned policy neural network neural network can be configured to receive an input that includes text and data characterizing the state of the environment and to generate, depending on the input, a policy output that defines an action to be performed by the agent. In some implementations, the natural language description of the task can be received during training of the language-conditioned policy neural network. The method may further comprise, after the training, providing data specifying the policy neural network for use in controlling a real-world (e.g., mechanical) agent in the real-world environment. In such cases, the method may therefore further comprise controlling the real-world agent using the trained language-conditioned policy neural network to perform a new task, which may be the same as or different from the task received during training. That is, the agent may be controlled by using the policy neural network to process an input that includes a natural language description of the new task, or a sub-goal of the new task, and data characterizing the state of the real-world environment to generate a policy output that defines an action to be performed by the agent in the real-world environment. In some implementations, the policy output that defines the action includes control signals to control the real-world (e.g., mechanical) agent.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example action selection system.

FIG. 2 is a flow diagram of an example process for instructing an agent during a task episode.

FIG. 3 is a flow diagram of an example process for generating training data for training a language-conditioned policy neural network.

FIG. 4 shows an example input sequence.

FIG. 5 shows an example of using the VLM to determine similarity scores between observation images and a sub-goal.

FIG. 6 shows an example of using the VLM and the language model neural network to generate training data.

FIG. 7 shows an example of repurposing offline data for a new task.

FIG. 8 shows an example of controlling a robot to perform a task episode using sub-goals.

FIG. 9 shows an example of the performance of the described techniques.

FIG. 10 shows another example of the performance of the described techniques.

Like reference numbers and designations in the various drawings indicate like elements.

### DETAILED DESCRIPTION

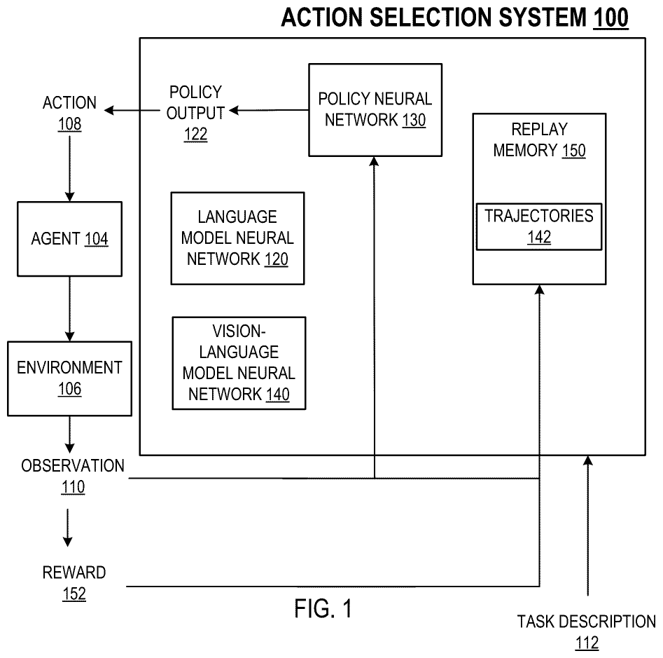

FIG. 1 shows an example action selection system 100. The action selection system 100 is an example of a system implemented as computer programs on one or more computers in one or more locations in which the systems, components, and techniques described below are implemented.

The action selection system 100 uses a language model neural network 120 and a vision-language model (VLM) neural network 140 to (i) improve controlling an agent 104 interacting with an environment 106 to perform a task in the environment 106 or (ii) assist an agent 104 interacting with an environment 106 to perform a task in the environment 106. For example, the agent 104 can be a robot, e.g., a robotic arm, a quadruped robot, a humanoid robot, or other type of robot that is controllable by the system 100.

Examples of agents, environments, and tasks will be described below.

When controlling the agent 104, the system 100 controls the agent 104 to accomplish a task by selecting actions 108 to be performed by the agent 104 at each of multiple time steps during the performance of an episode of the task.

An “episode” of a task is a sequence of interactions during which the agent attempts to perform an instance of the task starting from some starting state of the environment. In other words, each task episode begins with the environment being in an initial state, e.g., a fixed initial state or a randomly selected initial state, and ends when the agent has successfully completed the task or when some termination criterion is satisfied, e.g., the environment enters a state that has been designated as a terminal state or the agent performs a threshold number of actions without successfully completing the task.

At each time step during any given task episode, the system 100 receives an observation 110 characterizing the current state of the environment 106 at the time step and, in response, selects an action 108 to be performed by the agent 104 at the time step. After the agent 104 performs the action 108, the environment 106 transitions into a new state.

The observation 110 can include any appropriate information that characterizes the state of the environment. As one example, the observation 110 can include sensor readings from one or more sensors configured to sense the environment. For example, the observation 110 can include one or more images captured by one or more cameras, measurements from one or more proprioceptive sensors, and so on. For example, the observation 110 can comprise monochrome or color pixels of one or more images or videos. Each image may be a 2D or 3D image. As defined herein an “image” includes a point cloud e.g. from a LIDAR system, and a “pixel” includes a point of the point cloud.

In some cases, the system 100 receives an extrinsic reward 152 from the environment in response to the agent performing the action.

Generally, the reward is a scalar numerical value and characterizes a progress of the agent towards completing the task.

As a particular example, the reward can be a sparse binary reward that is zero unless the task is successfully completed and one if the task is successfully completed as a result of the action performed.

As another particular example, the reward can be a dense reward that measures a progress of the agent towards completing the task as of individual observations received during the episode of attempting to perform the task, i.e., so that non-zero rewards can be and frequently are received before the task is successfully completed.

More specifically, to control the agent 104 or to assist the agent 104 at a given time step, the system 100 receives, e.g., from a user, from a digital assistant, or from an external system, a natural language task description 112 that describes the task to be performed by the agent 104 during the task episode.

When the system 100 is controlling the agent 104, the system 100 selects an action 108 to be performed by the agent in response to the current observation using a language-conditioned policy neural network 130.

The language-conditioned policy neural network 130 is generally conditioned on both text and data characterizing the state of the environment (e.g., sensor readings from one or more sensors configured to sense the environment).

The data characterizing the state can be the same as the observation 110, can include only part of the information in the observation 110, or can include other information. For example, if the observation 110 includes an image and state information, e.g., positions and other state information for joints or other parts of the agent 104, positions of objects in the environment 110, or both, the data characterizing the state can include both image and state information, just the image, or just the state information.

In particular, the policy neural network 130 is a neural network that is configured to receive an input that includes text and data characterizing the state of the environment and to generate (depending on the input) a policy output 122 that defines an action to be performed by the agent.

In one example, the policy output 122 may include a respective Q-value for each action in a fixed set comprising a plurality of actions. The system 100 can process the Q-values (e.g., using a soft-max function) to generate a respective probability value for each action, which can be used to select the action or can select the action with the highest Q-value.

The Q-value for an action is an estimate of a “return” that would result from the agent performing the action in response to the current observation and thereafter being controlled using actions generated by the action selection system 100.

In another example, the policy output 122 may include a respective numerical probability value for each action in the fixed set. The system 100 can select the action, e.g., by sampling an action in accordance with the probability values, such as by selecting the action with the highest probability value.

As another example, when the action space is continuous the policy output 122 can include parameters of a probability distribution over the continuous action space. The system 100 can then select an action by sampling an action from the probability distribution or by selecting, for example, the mean action.

As yet another example, the policy output 122 can be a regressed action. That is, the policy output 122 can directly specify the numerical values of an action vector, e.g., torques to be applied or linear or angular velocities.

The policy neural network 130 can have any appropriate architecture that allows the policy neural network 130 to map environment state data and natural language text to a policy output 122.

For example, the policy neural network 130 can include one encoder for the environment data, another encoder for the text, and a policy subnetwork configured to process the outputs from the two encoders to generate the policy output. In some cases, the policy subnetwork can include a context neural network, e.g., a recurrent neural network or a Transformer neural network, so that the policy output 122 at a given time step incorporates information from previous time steps.

As a particular example, when the neural network 130 receives visual observations, e.g., images or videos, the neural network can have a convolutional visual encoder or a vision Transformer to encode visual observations, and a recurrent neural network, e.g., LSTM-based, or attention-based language encoder to encode action instructions. The neural network can also have a LSTM-based memory module to help take previous actions and observations into account for policy outputs.

As another particular example, the policy subnetwork can be a Transformer neural network that processes a sequence that includes the encoded environment data and the encoded text data to generate the policy output. Optionally, the sequence can also include encoded environment data from previous time steps and further optionally encodings of previous actions to help take previous actions and observations into account for policy outputs.

In some implementations, the system 100 conditions the policy neural network 130 on the natural language task description 112 at each time step during the task episode.

In some other implementations, while performing the task episode, the system 100 conditions the policy neural network 130 on data representing descriptions of a sequence of sub-goals (instead of the natural language task description 112) generated using the language model neural network 120. By conditioning the policy neural network 130 on descriptions of sub-goals rather than the task description 112, the system 100 effectively decomposes the task into smaller components that are more easily achievable by the agent 104, thereby increasing the success rate of the agent on the task specified by the description 112.

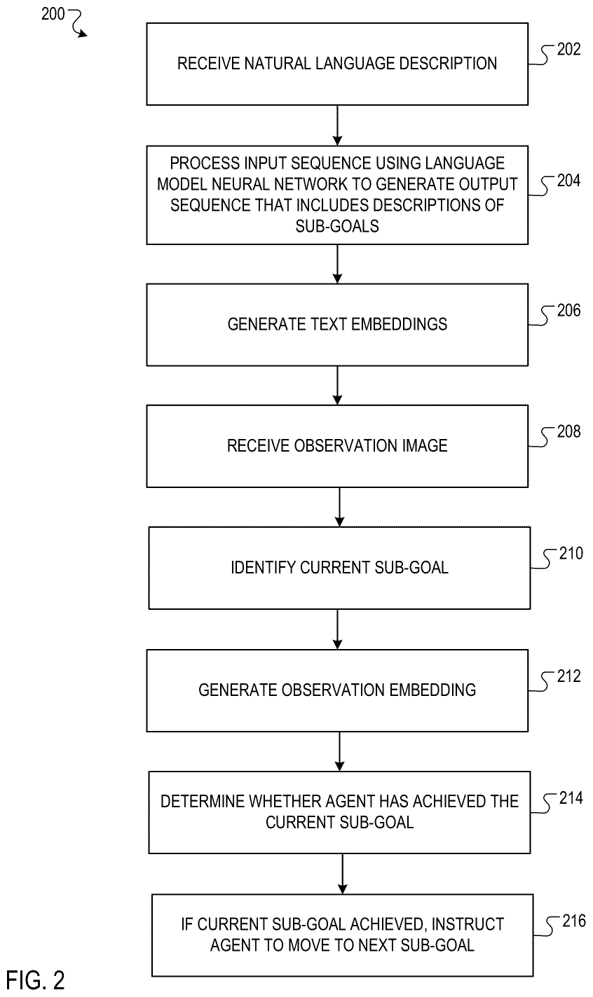

Generating sequences of sub-goals and using sub-goals during a task episode will be described in more detail below with reference to FIG. 2

In either of these implementations, the system 100 can use descriptions generated by the language model neural network 120 and embeddings of sub-goals and observation images generated by the vision-language model (VLM) neural network 140 to improve the training of the policy neural network 130.

In particular, prior to using the policy neural network 130 to control the agent to perform the task, the system 100 trains the policy neural network on training data stored in a replay memory 150 (which may be omitted after the policy neural network 130 has been trained).

For example, during the training, the system 100 can generate training data by controlling the agent and then store the training data in the replay memory 150. More specifically, the training data includes trajectories 142 of experience data generated from task episodes performed during the training.

Additionally, the system 100 can periodically sample training data from the replay memory 150 and train the policy neural network on the training data, e.g., through imitation learning or reinforcement learning.

The system 100 can use the language model neural network 120 and the VLM language model neural network 140 to improve the quality of the training data that is added to the replay memory 150, e.g., by adding “sub-trajectories” in which sub-goals were achieved to the replay memory 150, irrespective of whether the overall goal was achieved. Thus, the policy neural network 130 is trained on higher-quality data and can achieve improved performance after training.

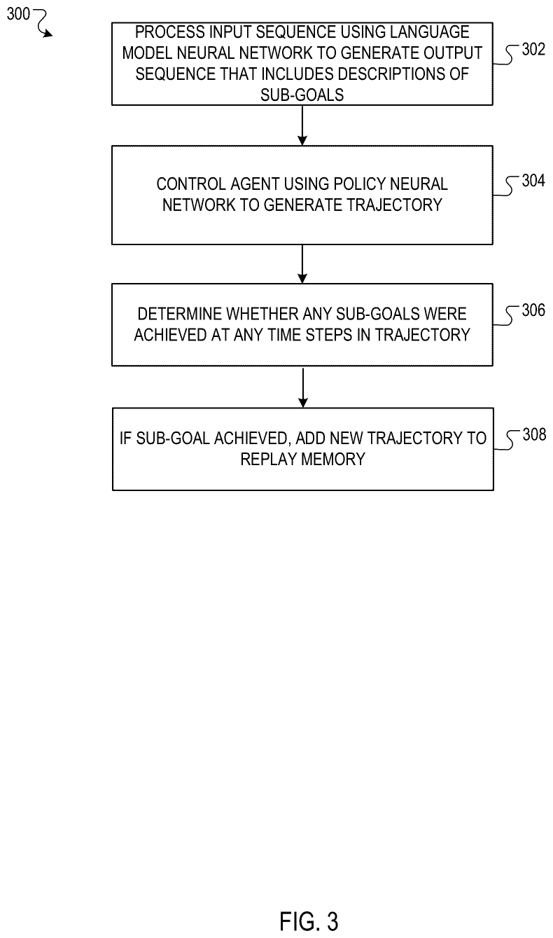

Training the policy neural network 130 is described in more detail below with reference to FIG. 3.

When the system is assisting the agent 104, the system 100 provides, to the agent 104, information about how to perform the task that is generated using natural language descriptions of the sub-goals generated by the language model neural network 120.

This is described in more detail below with reference to FIG. 2.

For example, the agent that is assisted can be a human. For example assisting the agent, i.e. the human, can include communicating with a human user of a digital assistant (also referred to as a virtual assistant) such as a smart speaker or display, mobile, or other device.

In more detail, in some implementations the agent comprises a human user of a digital assistant such as a smart speaker, smart display, or other device. Then, information defining the task can be obtained from the digital assistant, and the digital assistant can be used to provide information to the user based on the sub-goals. For example, this may comprise receiving, at the digital assistant, a request from the user for assistance and determining, in response to the request, one or more tasks for the user to perform, e.g., steps or sub-tasks of an overall task. Then for one or more tasks of the series of tasks, e.g., for each task, e.g., until a final task of the series the digital assistant can be used to output to the user information indicating how to perform the task. This may be done using natural language, e.g., on a display and/or using a speech synthesis subsystem of the digital assistant. Visual, e.g., video, and/or audio observations of the user performing the task may be captured, e.g., using the digital assistant.

As an illustrative example a user may be interacting with a digital assistant and ask for help performing an overall task consisting of multiple steps, e.g., cooking a pasta dish. While the user performs the task, the digital assistant receives audio and/or video inputs representative of the user's progress on the task, e.g., images or video or sound clips of the user cooking. The digital assistant uses a system as described above, in particular by providing it with the captured audio and/or video to determine how the user should complete each step.

In a further aspect there is provided a digital assistant device including a system as described above. The digital assistant can also include a user interface to enable a user to request assistance and to output information. In implementations this is a natural language user interface and may comprise a keyboard, voice input-output subsystem, and/or a display. The digital assistant can further include an assistance subsystem configured to determine, in response to the request, a series of tasks for the user to perform. In implementations this may comprise a generative (large) language model, in particular for dialog, e.g., a conversation agent such as LaMDA. The digital assistant can have an observation capture subsystem to capture visual and/or audio observations of the user performing a task; and an interface for the above-described language model neural network (which may be implemented locally or remotely). The digital assistant can also have an assistance control subsystem configured to assist the user. The assistance control subsystem can be configured to perform the steps described above, for one or more tasks, e.g., of a series of tasks, e.g., until a final task of the series. More particularly the assistance control subsystem can capture, using the observation capture subsystem, visual or audio observations of the user performing the task, determine how to perform the task, and provide information about how to perform the task.

Some examples of the types of agents the system can control now follow.

In some implementations, the environment is a real-world environment, the agent is a mechanical agent interacting with the real-world environment, e.g., a robot or an autonomous or semi-autonomous land, air, or sea vehicle operating in or navigating through the environment, and the actions are actions taken by the mechanical agent in the real-world environment to perform the task. For example, the agent may be a robot interacting with the environment to accomplish a specific task, e.g., to locate an object of interest in the environment or to move an object of interest to a specified location in the environment or to navigate to a specified destination in the environment.

In these implementations, the observations may include, e.g., one or more of: images, object position data, and sensor data to capture observations as the agent interacts with the environment, for example sensor data from an image, distance, or position sensor or from an actuator. For example in the case of a robot, the observations may include data characterizing the current state of the robot, e.g., one or more of: joint position, joint velocity, joint force, torque or acceleration, e.g., gravity-compensated torque feedback, and global or relative pose of an item held by the robot. In the case of a robot or other mechanical agent or vehicle the observations may similarly include one or more of the position, linear or angular velocity, force, torque or acceleration, and global or relative pose of one or more parts of the agent. The observations may be defined in 1, 2 or 3 dimensions, and may be absolute and/or relative observations. The observations may also include, for example, sensed electronic signals such as motor current or a temperature signal; and/or image or video data for example from a camera or a LIDAR sensor, e.g., data from sensors of the agent or data from sensors that are located separately from the agent in the environment.

In these implementations, the actions may be control signals to control the robot or other mechanical agent, e.g., torques for the joints of the robot or higher-level control commands, or the autonomous or semi-autonomous land, air, sea vehicle, e.g., torques to the control surface or other control elements, e.g., steering control elements of the vehicle, or higher-level control commands. The control signals can include for example, position, velocity, or force/torque/acceleration data for one or more joints of a robot or parts of another mechanical agent. The control signals may also or instead include electronic control data such as motor control data, or more generally data for controlling one or more electronic devices within the environment the control of which has an effect on the observed state of the environment. For example in the case of an autonomous or semi-autonomous land or air or sea vehicle the control signals may define actions to control navigation, e.g., steering, and movement, e.g., braking and/or acceleration of the vehicle.

In some implementations the environment is a simulation of the above-described real-world environment, and the agent is implemented as one or more computers interacting with the simulated environment. For example the simulated environment may be a simulation of a robot or vehicle and the reinforcement learning system may be trained on the simulation and then, once trained, used in the real-world.

In some implementations the environment is a real-world manufacturing environment for manufacturing a product, such as a chemical, biological, or mechanical product, or a food product. As used herein a “manufacturing” a product also includes refining a starting material to create a product, or treating a starting material, e.g., to remove pollutants, to generate a cleaned or recycled product. The manufacturing plant may comprise a plurality of manufacturing units such as vessels for chemical or biological substances, or machines, e.g., robots, for processing solid or other materials. The manufacturing units are configured such that an intermediate version or component of the product is moveable between the manufacturing units during manufacture of the product, e.g., via pipes or mechanical conveyance. As used herein manufacture of a product also includes manufacture of a food product by a kitchen robot.

The agent may comprise an electronic agent configured to control a manufacturing unit, or a machine such as a robot, that operates to manufacture the product. That is, the agent may comprise a control system configured to control the manufacture of the chemical, biological, or mechanical product. For example the control system may be configured to control one or more of the manufacturing units or machines or to control movement of an intermediate version or component of the product between the manufacturing units or machines.

As one example, a task performed by the agent may comprise a task to manufacture the product or an intermediate version or component thereof. As another example, a task performed by the agent may comprise a task to control, e.g., minimize, use of a resource such as a task to control electrical power consumption, or water consumption, or the consumption of any material or consumable used in the manufacturing process.

The actions may comprise control actions to control the use of a machine or a manufacturing unit for processing a solid or liquid material to manufacture the product, or an intermediate or component thereof, or to control movement of an intermediate version or component of the product within the manufacturing environment, e.g., between the manufacturing units or machines. In general the actions may be any actions that have an effect on the observed state of the environment, e.g., actions configured to adjust any of the sensed parameters described below. These may include actions to adjust the physical or chemical conditions of a manufacturing unit, or actions to control the movement of mechanical parts of a machine or joints of a robot. The actions may include actions imposing operating conditions on a manufacturing unit or machine, or actions that result in changes to settings to adjust, control, or switch on or off the operation of a manufacturing unit or machine.

The rewards or return may relate to a metric of performance of the task. For example in the case of a task that is to manufacture a product the metric may comprise a metric of a quantity of the product that is manufactured, a quality of the product, a speed of production of the product, or to a physical cost of performing the manufacturing task, e.g., a metric of a quantity of energy, materials, or other resources, used to perform the task. In the case of a task that is to control use a resource the matric may comprise any metric of usage of the resource.

In general observations of a state of the environment may comprise any electronic signals representing the functioning of electronic and/or mechanical items of equipment. For example a representation of the state of the environment may be derived from observations made by sensors sensing a state of the manufacturing environment, e.g., sensors sensing a state or configuration of the manufacturing units or machines, or sensors sensing movement of material between the manufacturing units or machines. As some examples such sensors may be configured to sense mechanical movement or force, pressure, temperature; electrical conditions such as current, voltage, frequency, impedance; quantity, level, flow/movement rate or flow/movement path of one or more materials; physical or chemical conditions, e.g., a physical state, shape or configuration or a chemical state such as pH; configurations of the units or machines such as the mechanical configuration of a unit or machine, or valve configurations; image or video sensors to capture image or video observations of the manufacturing units or of the machines or movement; or any other appropriate type of sensor. In the case of a machine such as a robot the observations from the sensors may include observations of position, linear or angular velocity, force, torque or acceleration, or pose of one or more parts of the machine, e.g., data characterizing the current state of the machine or robot or of an item held or processed by the machine or robot. The observations may also include, for example, sensed electronic signals such as motor current or a temperature signal, or image or video data for example from a camera or a LIDAR sensor. Sensors such as these may be part of or located separately from the agent in the environment.

In some implementations the environment is the real-world environment of a service facility comprising a plurality of items of electronic equipment, such as a server farm or data center, for example a telecommunications data center, or a computer data center for storing or processing data, or any service facility. The service facility may also include ancillary control equipment that controls an operating environment of the items of equipment, for example environmental control equipment such as temperature control, e.g., cooling equipment, or air flow control or air conditioning equipment. The task may comprise a task to control, e.g., minimize, use of a resource, such as a task to control electrical power consumption, or water consumption. The agent may comprise an electronic agent configured to control operation of the items of equipment, or to control operation of the ancillary, e.g., environmental, control equipment.

In general the actions may be any actions that have an effect on the observed state of the environment, e.g., actions configured to adjust any of the sensed parameters described below. These may include actions to control, or to impose operating conditions on, the items of equipment or the ancillary control equipment, e.g., actions that result in changes to settings to adjust, control, or switch on or off the operation of an item of equipment or an item of ancillary control equipment.

In general observations of a state of the environment may comprise any electronic signals representing the functioning of the facility or of equipment in the facility. For example a representation of the state of the environment may be derived from observations made by any sensors sensing a state of a physical environment of the facility or observations made by any sensors sensing a state of one or more of items of equipment or one or more items of ancillary control equipment. These include sensors configured to sense electrical conditions such as current, voltage, power or energy; a temperature of the facility; fluid flow, temperature or pressure within the facility or within a cooling system of the facility; or a physical facility configuration such as whether or not a vent is open.

The rewards or return may relate to a metric of performance of the task. For example in the case of a task to control, e.g., minimize, use of a resource, such as a task to control use of electrical power or water, the metric may comprise any metric of use of the resource.

In some implementations the environment is the real-world environment of a power generation facility, e.g., a renewable power generation facility such as a solar farm or wind farm. The task may comprise a control task to control power generated by the facility, e.g., to control the delivery of electrical power to a power distribution grid, e.g., to meet demand or to reduce the risk of a mismatch between elements of the grid, or to maximize power generated by the facility. The agent may comprise an electronic agent configured to control the generation of electrical power by the facility or the coupling of generated electrical power into the grid. The actions may comprise actions to control an electrical or mechanical configuration of an electrical power generator such as the electrical or mechanical configuration of one or more renewable power generating elements, e.g., to control a configuration of a wind turbine or of a solar panel or panels or mirror, or the electrical or mechanical configuration of a rotating electrical power generation machine. Mechanical control actions may, for example, comprise actions that control the conversion of an energy input to an electrical energy output, e.g., an efficiency of the conversion or a degree of coupling of the energy input to the electrical energy output. Electrical control actions may, for example, comprise actions that control one or more of a voltage, current, frequency or phase of electrical power generated.

The rewards or return may relate to a metric of performance of the task. For example in the case of a task to control the delivery of electrical power to the power distribution grid the metric may relate to a measure of power transferred, or to a measure of an electrical mismatch between the power generation facility and the grid such as a voltage, current, frequency or phase mismatch, or to a measure of electrical power or energy loss in the power generation facility. In the case of a task to maximize the delivery of electrical power to the power distribution grid the metric may relate to a measure of electrical power or energy transferred to the grid, or to a measure of electrical power or energy loss in the power generation facility.

In general observations of a state of the environment may comprise any electronic signals representing the electrical or mechanical functioning of power generation equipment in the power generation facility. For example a representation of the state of the environment may be derived from observations made by any sensors sensing a physical or electrical state of equipment in the power generation facility that is generating electrical power, or the physical environment of such equipment, or a condition of ancillary equipment supporting power generation equipment. Such sensors may include sensors configured to sense electrical conditions of the equipment such as current, voltage, power or energy; temperature or cooling of the physical environment; fluid flow; or a physical configuration of the equipment; and observations of an electrical condition of the grid, e.g., from local or remote sensors. Observations of a state of the environment may also comprise one or more predictions regarding future conditions of operation of the power generation equipment such as predictions of future wind levels or solar irradiance or predictions of a future electrical condition of the grid.

As another example, the environment may be a chemical synthesis or protein folding environment such that each state is a respective state of a protein chain or of one or more intermediates or precursor chemicals and the agent is a computer system for determining how to fold the protein chain or synthesize the chemical. In this example, the actions are possible folding actions for folding the protein chain or actions for assembling precursor chemicals/intermediates and the result to be achieved may include, e.g., folding the protein so that the protein is stable and so that it achieves a particular biological function or providing a valid synthetic route for the chemical. As another example, the agent may be a mechanical agent that performs or controls the protein folding actions or chemical synthesis steps selected by the system automatically without human interaction. The observations may comprise direct or indirect observations of a state of the protein or chemical/intermediates/precursors and/or may be derived from simulation.

In a similar way the environment may be a drug design environment such that each state is a respective state of a potential pharmaceutically active compound and the agent is a computer system for determining elements of the pharmaceutically active compound and/or a synthetic pathway for the pharmaceutically active compound. The drug/synthesis may be designed based on a reward derived from a target for the drug, for example in simulation. As another example, the agent may be a mechanical agent that performs or controls synthesis of the drug.

In some further applications, the environment is a real-world environment and the agent manages distribution of tasks across computing resources, e.g., on a mobile device and/or in a data center. In these implementations, the actions may include assigning tasks to particular computing resources.

As further example, the actions may include presenting advertisements, the observations may include advertisement impressions or a click-through count or rate, and the reward may characterize previous selections of items or content taken by one or more users.

In some cases, the observations may include textual or spoken instructions provided to the agent by a third-party (e.g., an operator of the agent). For example, the agent may be an autonomous vehicle, and a user of the autonomous vehicle may provide textual or spoken instructions to the agent (e.g., to navigate to a particular location).

As another example the environment may be an electrical, mechanical or electro-mechanical design environment, e.g., an environment in which the design of an electrical, mechanical or electro-mechanical entity is simulated. The simulated environment may be a simulation of a real-world environment in which the entity is intended to work. The task may be to design the entity. The observations may comprise observations that characterize the entity, i.e., observations of a mechanical shape or of an electrical, mechanical, or electro-mechanical configuration of the entity, or observations of parameters or properties of the entity. The actions may comprise actions that modify the entity, e.g., that modify one or more of the observations. The rewards or return may comprise one or more metric of performance of the design of the entity. For example rewards or return may relate to one or more physical characteristics of the entity such as weight or strength or to one or more electrical characteristics of the entity such as a measure of efficiency at performing a particular function for which the entity is designed. The design process may include outputting the design for manufacture, e.g., in the form of computer executable instructions for manufacturing the entity. The process may include making the entity according to the design. Thus a design an entity may be optimized, e.g., by reinforcement learning, and then the optimized design output for manufacturing the entity, e.g., as computer executable instructions; an entity with the optimized design may then be manufactured.

As previously described the environment may be a simulated environment. Generally in the case of a simulated environment the observations may include simulated versions of one or more of the previously described observations or types of observations and the actions may include simulated versions of one or more of the previously described actions or types of actions. For example the simulated environment may be a motion simulation environment, e.g., a driving simulation or a flight simulation, and the agent may be a simulated vehicle navigating through the motion simulation. In these implementations, the actions may be control inputs to control the simulated user or simulated vehicle. Generally the agent may be implemented as one or more computers interacting with the simulated environment.

The simulated environment may be a simulation of a particular real-world environment and agent. For example, the system may be used to select actions in the simulated environment during training or evaluation of the system and, after training, or evaluation, or both, are complete, may be deployed for controlling a real-world agent in the particular real-world environment that was the subject of the simulation. This can avoid unnecessary wear and tear on and damage to the real-world environment or real-world agent and can allow the control neural network to be trained and evaluated on situations that occur rarely or are difficult or unsafe to re-create in the real-world environment. For example the system may be partly trained using a simulation of a mechanical agent in a simulation of a particular real-world environment, and afterwards deployed to control the real mechanical agent in the particular real-world environment. Thus in such cases the observations of the simulated environment relate to the real-world environment, and the selected actions in the simulated environment relate to actions to be performed by the mechanical agent in the real-world environment.

Optionally, in any of the above implementations, the observation at any given time step may include data from a previous time step that may be beneficial in characterizing the environment, e.g., the action performed at the previous time step, the reward received at the previous time step, or both.

FIG. 2 is a flow diagram of an example process 200 for controlling the agent during a task episode. For convenience, the process 200 will be described as being performed by a system of one or more computers located in one or more locations. For example, an action selection system, e.g., the action selection system 100 of FIG. 1, appropriately programmed in accordance with this specification, can perform the process 200.

The system receives a natural language description of the task to be performed by the agent (step 202). For example, the system can receive the description as a text input from a user or an external system. As another example, the system can receive the description as a speech input from a user or an external system and then apply a speech recognizer to the speech input to generate the natural language description. As yet another example, the system can receive the description as a speech input and then apply a tokenizer to the speech input to map the speech input to a set of tokens that are in the same embedding space as the input tokens processed by the language model neural network.

The system processes, using a language model neural network, an input sequence derived from the natural language description of the task to generate an output text sequence (step 204).

The output text sequence includes natural language descriptions of each of a sequence of sub-goals to be achieved by the agent while performing the task. That is, the output sequence specifies a partitioning or decomposition of the task into a sequence of sub-goals that, if successfully performed by the agent, will result in the agent successfully performing the task.

In some cases, the input sequence includes a k-shot prompt, where k is an integer greater than or equal to one, that causes the language model neural network to generate the descriptions of the sub-goals. In these cases, the input sequence includes k, i.e., one or more, prompt sequences with each prompt sequence including (i) an example natural language task description and (iii) an example output sequence comprising example natural language descriptions of example sub-goals.

In some of these cases, within each example output sequence, the example natural language descriptions of example sub-goals can be arranged according to a particular syntax e.g., separated by specific tokens within the input sequence. In these cases, the system can identify the natural language descriptions in the output sequence by parsing the output sequence according to the particular syntax.

Instead of or in addition to the k-shot prompt, the input sequence can also include a natural language instruction that causes the language model neural network to generate the descriptions of the sub-goals. For example, the natural language instruction can include a description of the environment, e.g., of the agent, of the objects in the environment, the current location of the agent in the environment, and so on.

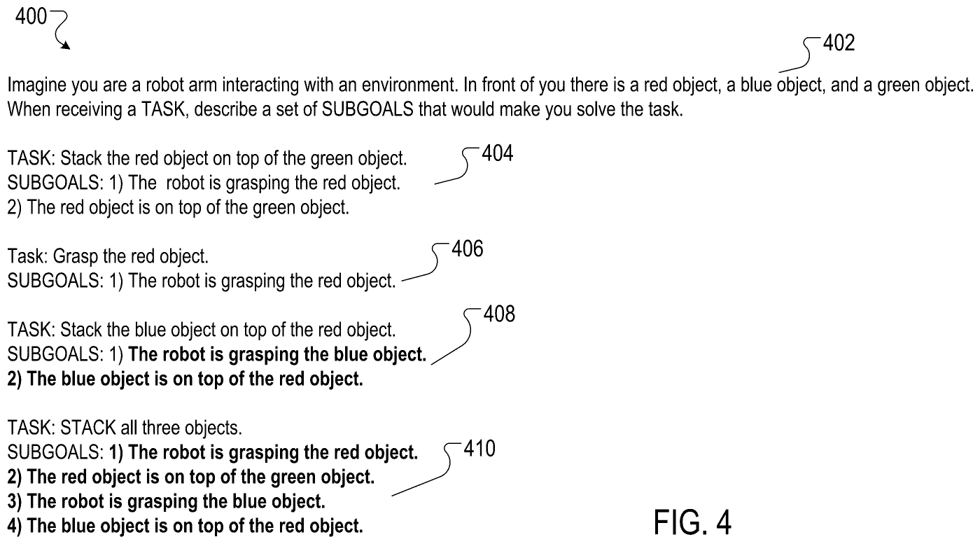

An example of an input sequence that can be provided to the language model neural network is shown below with reference to FIG. 4.

FIG. 4 shows an example 400 of an input sequence 402 that can be provided as input to the language model neural network for a task that requires a robot arm to stack three objects in the environment.

As shown in FIG. 4, the input sequence 402 includes an instruction 404 that indicates that the agent is a robot arm and identifies the three objects that are near the agent in the environment.

The input sequence 402 also includes three prompt sequences 406 that each include (i) an example natural language task description and (iii) an example output sequence that each include example natural language descriptions of example sub-goals.

Finally, the input sequence 402 includes a natural language description 408 (“stack all three objects”) of the current task.

By processing the input sequence 402, the language model neural network generates an output sequence 410 (denoted in bold font in the Figure). As can be seen from FIG. 4, the output sequence partitions the task into four sub-goals and includes a natural language description of each.

The language model neural network can generally have any appropriate architecture that allows the language model neural network to map input text sequences to output text sequences. As a particular example, the language model neural network can be an encoder-decoder or decoder-only Transformer or a recurrent neural network (RNN) that auto-regressively generates the output sequence conditioned on the input sequence.

Generally, the language model neural network has been trained on a corpus of training data on a language modeling task, e.g., a task that requires predicting, given a current sequence of text tokens, the next token that follows the current sequence in the training data. As a particular example, the language model neural network can be pre-trained on a maximum-likelihood objective on a large dataset that includes text, e.g., text that is publicly available from the Internet or another text corpus. For example, the system can obtain a pre-trained language model neural network that has been trained on the language modeling task and, optionally, on one or more additional tasks, e.g., one or more of instruction tuning, supervised fine tuning, reinforcement learning from human or AI feedback, direct preference tuning, and so on.

In some implementations, the system can use the language model neural network without re-training the language model neural network. That is, the system can obtain and use an already-trained language model neural network and does not train the neural network on the specific task of decomposing tasks into sub-goals.

That is, by including the k-shot prompts, the instructions, or both in the input sequence, the system causes the language model neural network to accurately decompose tasks without having been trained on the specific tasks by leveraging the general-purpose text understanding and generation capabilities of the trained language model neural network.

Returning to the description of FIG. 2, the system generates a respective text embedding for each of the sub-goals in the sequence by processing the natural language description of the sub-goal using a vision-language model (VLM) neural network (step 206).

That is, the system processes each natural language description using the VLM to generate an embedding of the natural language description and uses the embedding as the text embedding of the corresponding sub-goal.

The VLM can be any appropriate neural network that receives images and text as input and generates representations (“embeddings”) of the images and the text in an embedding space. More specifically, the VLM can include any of a variety of learned embedders that generate embeddings of images and text in the embedding space. The embedders can be, e.g., encoder neural networks, multi-layer perceptrons (MLPs) learned linear layers, and so on.

For example, the VLM can include an image encoder neural network, e.g., a Vision Transformer or a convolutional neural network, that processes an image to generate an embedding of the image and a text encoder neural network, e.g., a Transformer-based decoder neural network, that receives text as input and generates an embedding of the text. The image encoder and the text encoder can have been jointly trained, e.g., through contrastive learning. One example of such a VLM is the CLIP model. Another example of such a VLM is the Align model. Thus, in this example, the VLM includes two encoder neural networks, but no decoder neural network.

As another example, the VLM can include an encoder neural network, e.g., a Vision Transformer or a convolutional neural network, that processes an image to generate an encoded representation of the image and a decoder neural network, e.g., a Transformer-based decoder neural network, that generates the text conditioned on the encoded representation of the image and, optionally, embeddings of the input text. One example of such a VLM is the Flamingo model described in Flamingo: a Visual Language Model for Few-Shot Learning, available at arXiv:2204.14198. Another example of a VLM is described in Multimodal Few-Shot Learning with Frozen Language Models, available at arXiv: 2106.13884.

As another example, the VLM neural network can include an embedding component, e.g., one that embeds an input image using an encoder neural network, a linear layer, or a deterministic embedding operation, and then processes the embedding of the input images (and, optionally, embeddings of other images or inputs of other modalities) using a decoder-only Transformer neural network.

The VLM may have been trained on a data set that includes both images and text, e.g., through contrastive learning or another representation learning technique, so that an image that is accurately described by a text sequence will have an embedding that is similar to, i.e., close to, the embedding of the text sequence.

In some implementations, the system uses a VLM that has been trained on a general data set of images and text, i.e., without further training the VLM.

In some other implementations, the system further trains (“fine-tunes”) the VLM to improve the accuracy of determining sub-goal completion using the VLM. For example, the system can fine-tune the VLM on a data set that includes images of the environment and corresponding text descriptions. For example, the data set can include images of the environment with various configurations of the agent and possible objects in the environment. This “in-domain” training data can make similarity scores generated using the VLM more accurately reflect similarities between sub-goals and observation images. In particular, the system can achieve this benefit with relatively few “in-domain” images. As a particular example, when the pre-training data set has approximately 10\hat{ }8 images, the fine-tuning data set can have 10\hat{ }3 images or fewer and realize the described improvements.

In other words, in these implementations, prior to use, the VLM has been pre-trained on a first training data set of images and corresponding text descriptions and fine-tuned on a second training data set that includes images of the environment and corresponding text descriptions.

In some implementations, the language model neural network can be part of the VLM, e.g., can be the text encoder neural network of the VLM, a text decoder neural network of the VLM, or one or more text embedding layers of the VLM. As another example, the language model neural network and the VLM can be the same neural network, e.g., in the case where the VLM can process tokens representing images, text, and, optionally, other modalities. In other implementations, the language model neural network is a separate neural network from the VLM, e.g., the language model neural network can be a decoder-only Transformer neural network that is separate from the VLM.

The system then assists the agent or controls the agent to perform the task episodes by performing steps 208-216 at each of one or more time steps in the task episode. For example, the system can perform the steps 208-216 at each time step during the task episode or at a subset of time steps during the task episode, e.g., every five, ten, or twenty time steps during the episode.

The system receives a current observation image characterizing a current state of the environment at the time step (step 208). For example, the image can be taken by a camera sensor of the mechanical agent (e.g., robot) or by a camera sensor positioned externally to the mechanical agent in the environment.

The system identifies a current sub-goal in the sequence of sub-goals being performed by the agent at the time step (step 210). That is, the system identifies the latest sub-goal in the sequence that has not yet been achieved by the agent.

The system generates, using the VLM neural network and from the current observation image, an observation embedding of the current observation image (step 212). That is, the system processes the observation image using the VLM to generate the embedding of the observation image. For example, the system can process the observation image using the image encoder of the VLM to generate the embedding.

The system determines, from the observation embedding of the current observation and the text embedding of the current sub-goal, whether the agent has successfully achieved the current sub-goal in the sequence as of the time step (step 214).

For example, the system can compute a similarity score between the observation embedding of the current observation and the text embedding of the current sub-goal and then determine that the agent has successfully achieved the current sub-goal when the similarity score satisfies a threshold (i.e., satisfies a criterion that depends on the threshold). As a particular example, the similarity score can be a dot product and the threshold can be satisfied when the dot product exceeds the threshold.

In response to determining that the agent has successfully achieved the current sub-goal in the sequence as of the time step, the system instructs the agent to perform a next sub-goal that follows the current sub-goal in the sequence of sub-goals (step 216). That is, the system instructs the agent to begin attempting to achieve the next sub-goal that follows the current sub-goal in the sequence of sub-goals.

For example, when the system is controlling the agent, the system can determine, from the natural language description of the next sub-goal, one or more actions to be performed by the agent and then cause the agent to perform the one or more actions.

As a particular example, as part of determining the one or more actions, the system can process an input that includes (i) data characterizing the current state of the environment and (ii) data representing the natural language description of the next sub-goal using a language-conditioned policy neural network to generate a policy output that defines an action to be performed by the agent and then select an action using the policy output.

When the system is assisting the agent, the system can instruct the agent to perform the next sub-goal by providing a message, e.g., a text message or an audio message, to the agent that includes or is derived from the natural language description of the next sub-goal.

In response to determining that the agent has not successfully achieved the current sub-goal in the sequence as of the time step, the system can refrain from instructing the agent to perform the next sub-goal that follows the current sub-goal in the sequence.

For example, when assisting the agent, the system can refrain from providing a message to the agent or provide a message to the agent that instructs the agent to continue performing the current sub-goal.

When controlling the agent, the system can determine, from the natural language description of the current sub-goal, one or more actions to be performed by the agent and then cause the agent to perform the one or more actions.

As a particular example, as part of determining the one or more actions, the system can process an input that includes (i) data characterizing the current state of the environment and (ii) data representing the natural language description of the current sub-goal using the language-conditioned policy neural network to generate a policy output that defines an action to be performed by the agent and then select an action using the policy output.

Thus, the system can use the language model neural network and the VLM to both partition the task into sub-goals and to also “automatically” determine when each sub-goal is achieved without requiring any additional information from the environment other than the observations.

FIG. 3 is a flow diagram of an example process 300 for generating training data for training a language-conditioned policy neural network. For convenience, the process 300 will be described as being performed by a system of one or more computers located in one or more locations. For example, an action selection system, e.g., the action selection system 100 of FIG. 1, appropriately programmed in accordance with this specification, can perform the process 300.

In particular, during the training of the policy neural network, the system can repeatedly perform iterations of the process 300 in order to add training data, i.e., trajectories, to a replay memory.

During the training, the system can also repeatedly perform iterations of a training process. For example, the system can perform iterations of the training process after every one or more iterations of the process 300 or asynchronously from performing the process 300.

At each iteration of the training process, the system selects one or more trajectories from the replay memory and trains the policy neural network on the one or more trajectories. In some implementations, the system trains the policy neural network through imitation learning. In some other implementations, the system trains the policy neural network through reinforcement learning. In yet other implementations, the system trains the policy neural network through a technique that combines imitation learning and reinforcement learning.

At each iteration of the process 300, the system processes, using a language model neural network, an input sequence derived from a natural language description of a task to generate an output text sequence that includes natural language descriptions of each of a sequence of sub-goals to be achieved by the agent while performing the task (step 302). The input and output sequences are described in more detail above.

The system controls the agent using the language-conditioned policy neural network to perform a task episode of the task (step 304).

For example, the system can control the agent by, at each time step, conditioning the language-conditioned policy neural network on environment state data and the natural language description of the task. As described above, the task episode can terminate when a termination criterion is satisfied, e.g., the system receives a reward or other signal that indicates that the task has been successfully completed, a threshold number of time steps or a threshold amount of time have elapsed, the environment enters a state that has been designated as a terminal state, or another appropriate criterion. That is, the task episode may terminate without the task having been successfully performed.

As a result, the system generates a trajectory that includes experience data for each of a sequence of time steps during the task episode. The experience data for at least some of the time steps of the sequence of time steps generally includes a respective observation image for the time step. The experience data will also generally include the action that was performed at the time step and, optionally, the reward that was received at the time step.

Each trajectory is also generally associated with a description of a task that the agent was performing when the trajectory was generated.

The system determines, using the vision-language model (VLM) neural network, whether any of the sub-goals in the sequence were successfully achieved by the agent at any of the sequence of time steps (step 306).

As part of determining whether any of the sub-goals in the sequence were achieved, the system can generate a respective text embedding for each of the sub-goals in the sequence by processing the natural language description of the sub-goal using the VLM, e.g., as described above.

For each time step, the system can generate, using the VLM neural network and from the observation image for the time step (also referred to as the “current observation image” for the time step), an observation embedding of the observation image, e.g., as described above.

Then, for each time step and for each sub-goal, the system can determine, from the observation embedding of the observation image for the time step and the text embedding of the sub-goal, whether the agent has successfully achieved the sub-goal as of the time step.

For example, to determine whether the agent has successfully achieved a given sub-goal as of a given time step, the system can compute a similarity score between the observation embedding of the observation image for the given time step and the text embedding of the given sub-goal and then determine that the agent has successfully achieved the given sub-goal when the similarity score satisfies a threshold. As a particular example, the similarity score can be a dot product and the threshold can be satisfied when the dot product exceeds the threshold.

In response to determining that a given sub-goal was achieved at a given time step of the plurality of time steps, the system adds a trajectory that includes experience data for time steps preceding the given time step in the task episode to a replay memory for use in training the policy neural network (step 308).

That is, the system generates a “sub-trajectory” that includes only the experience data for the time steps preceding the given time step at which the given sub-goal was achieved and adds the sub-trajectory to the replay memory. The system can associate this trajectory with a natural language description of the given sub-goal. Thus, when the policy neural network is later trained on this trajectory, the policy neural network can learn the sequence of actions that resulted in the sub-goal being successfully achieved. Moreover, because the sub-goal was generated by the language model neural network, learning to achieve the sub-goal is useful to performing larger tasks in the environment. When the system trains the policy neural network using a technique that incorporates reinforcement learning, the system can also associate a reward indicating that the given sub-goal was successfully completed.

As described above, in some implementations, the system also receives rewards in response to performing actions in the environment. In these implementations, at the completion of the task episode, the system can receive a reward that indicates whether the task was successfully performed during the task episode. When the reward indicates that the task was successfully performed, the system can add the (entire) trajectory generated at step 304 to the replay memory.

While FIG. 3 illustrates step 304 as being performed after step 302, it will be understood that the steps can be performed in any appropriate order. For example, the system can first generate a trajectory by performing step 304 and then perform the remaining steps of the process 300 in order to determine what data to add to the replay memory.

In some implementations, in order to further improve the quality of the training data by generating additional high-quality training data to be included in the replay memory, the system can “re-purpose” or “re-use” previous task trajectories for a previous task into training data for the current task using the language model neural network and the VLM.

In particular, the policy neural network or a different policy neural network may have already been trained to control the agent to perform one or more previous tasks.

In these cases, the system can access a plurality of previous task trajectories for a previous task, e.g., that were used as training data in training the policy neural network for the previous task. For example, each previous task trajectory can have been generated while the policy neural network was conditioned on data representing a description of a respective different task, i.e., a different task than the one described above with reference to FIG. 3.

For each previous task trajectory, the system can determine, using the VLM neural network, whether any of the sub-goals in the sequence were successfully achieved by the agent at any of the plurality of time steps in the previous task trajectory, e.g., as described above. That is, although the sub-goals were generated from the description of the “current” task, the system uses the VLM neural network to determine if any of those sub-goals were achieved by the agent while attempting to perform a different task.

In response to determining that a given sub-goal was achieved at a given time step in a given previous task trajectory, the system adds a trajectory that includes experience data for time steps preceding the given time step in the previous task trajectory to the replay memory for use in training the policy neural network, i.e. for use in training the policy neural network to perform the current set of tasks.

Thus, the system is able to “re-purpose” already generated training data to generate additional training data that is relevant for the current set of tasks, allowing for faster learning. Moreover, the system can generate this additional training data without needing to control the agent, which reduces wear and tear on the agent and reduces the likelihood of damaging the agent or the environment.

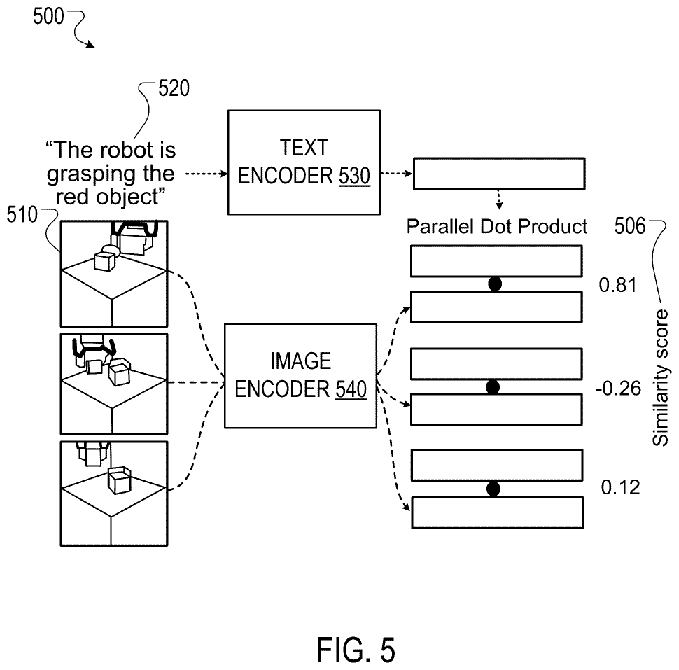

FIG. 5 shows an example 500 of using the VLM 140 to determine similarity scores between observation images 510 and a sub-goal 520.

In the example of FIG. 5, the system processes the sub-goal 520 using a text encoder 530 of the VLM 140 to generate a text embedding of the sub-goal 520.

The system also processes each of the observation images 520 using an image encoder 540 of the VLM 140 to generate a respective observation embedding of each of the observation images 520.

The system can then compute, for each observation image, a similarity score 506 between the observation embedding of the observation image and the text embedding of the sub-goal.

The system can then determine that the agent has successfully achieved the sub-goal at the time step corresponding to a given observation if the similarity score satisfies a threshold.

In the example of FIG. 5, the similarity score is a dot product and the threshold can be satisfied when the dot product exceeds the threshold.

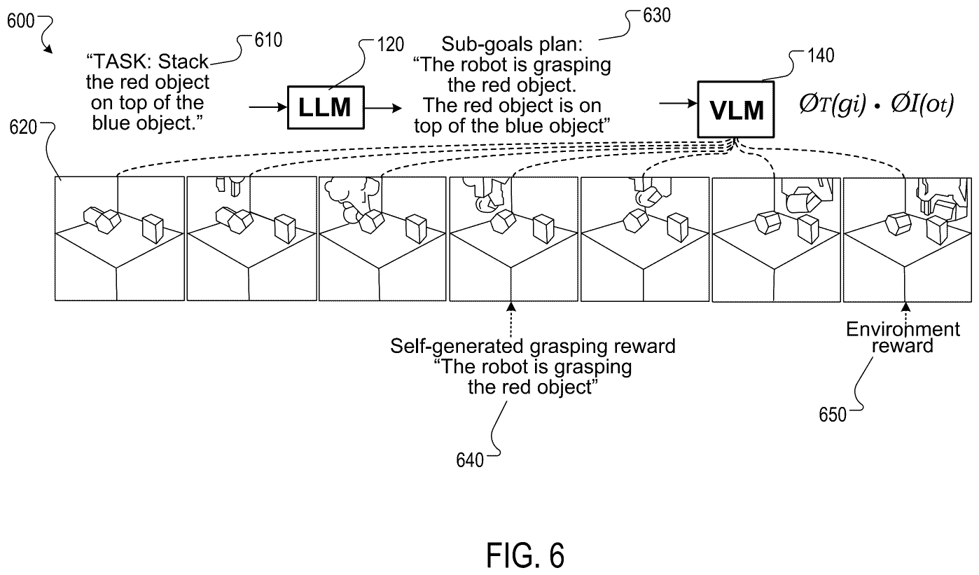

FIG. 6 shows an example 600 of using the VLM 140 and the language model neural network 120 to generate training data.

In the example of FIG. 6, the system receives a natural language task description 610 for a trajectory 620.

The system uses the language model neural network (LLM) 120 to generate, from the task description 610, a plan 630 that includes natural language descriptions of a sequence of sub-goals.

For each time step in the trajectory 620, the system determines whether any of the sub-goals were satisfied using the VLM 140 as described above. In the example of FIG. 6, the system determines that a sub-goal “the robot is grasping the red object” is satisfied at time step 640. As a result, the system can add a trajectory that includes the time steps preceding the time step 640 to the replay memory. The system also receives an environment reward 650 at the end of the trajectory 620 and can determine from the environment reward 650 whether to add the entire trajectory 620 to the replay memory.

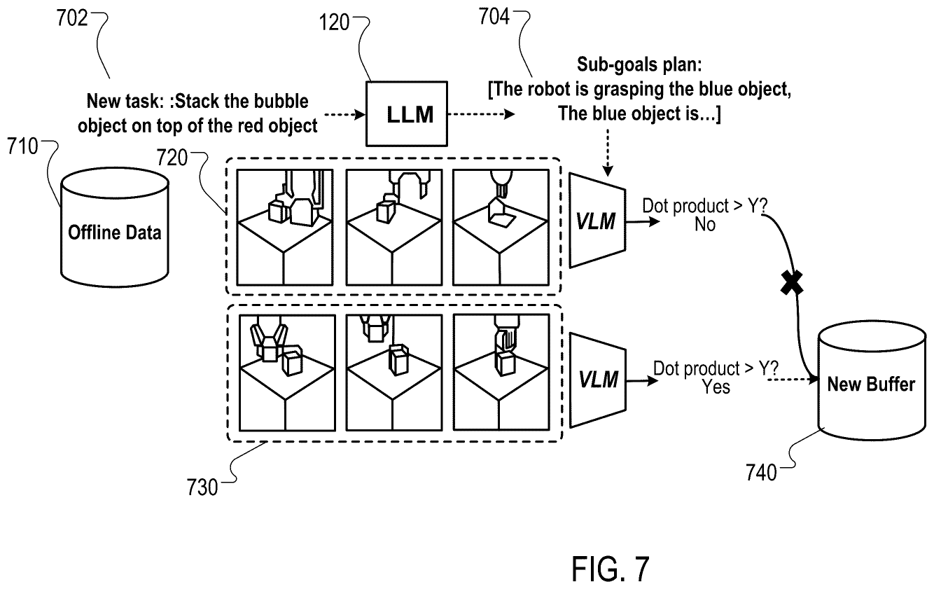

FIG. 7 shows an example 700 of repurposing offline data 710 for a new task 702 (e.g., trajectories that were generated for a different task).

As shown in FIG. 7, the system extracts two trajectories 720 and 730 from the offline data 710. The system then determines that, for the trajectory 720, none of the sub-goals 704 for the new task 702 were achieved at any of the time steps in the trajectory 720. As a result, the system does not add the trajectory to a new buffer 740 for use in training on the new task 702.

However, the system determines that one of the sub-goals was completed in the last time step of the trajectory 730. As a result, the system adds the trajectory 730 to the new buffer 740.

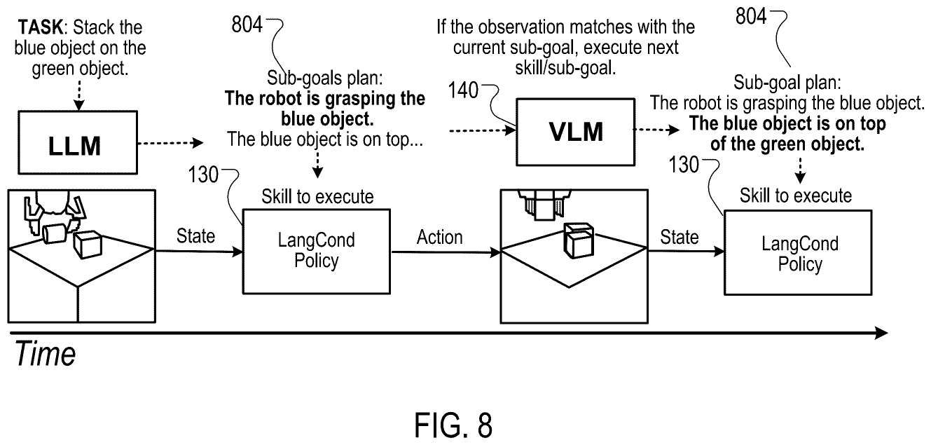

FIG. 8 shows an example 800 of controlling a robot to perform a task episode using sub-goals.

As can be seen from FIG. 8, at any given time step, the system conditions the language-conditioned policy neural network 130 on one of a sequence of sub-goals 804 generated using the language model neural network 120. In particular, the description of the sub-goal that is used to condition the neural network 130 at any given time step is highlighted in bold font in FIG. 8. The system uses the VLM 140 to determine whether to, at any given time step, switch to “executing” the next sub-goal, i.e., switch to conditioning the policy neural network 130 on the next sub-goal in the sequence.

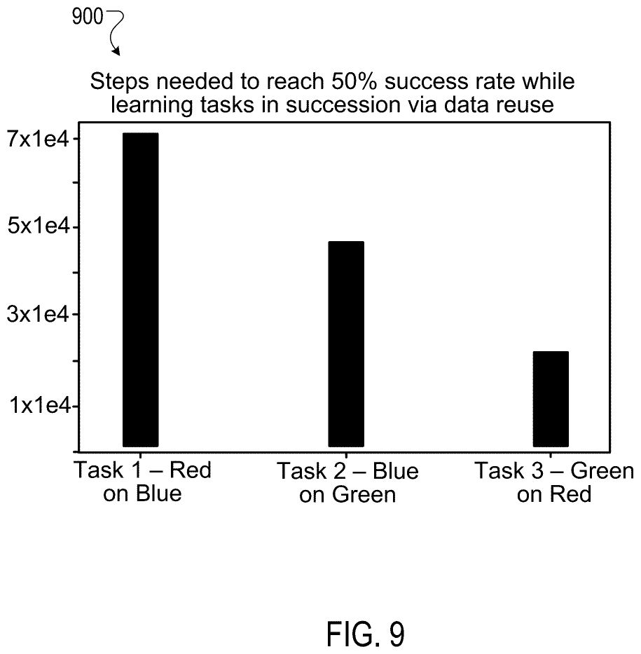

FIG. 9 shows an example 900 of the performance of the described techniques.

In particular, FIG. 9 shows how the repurposing of training data for new tasks speeds up learning across three robotic stacking tasks. As can be seen from FIG. 9, by repurposing training data for the first two tasks, the robot achieves a 50% success on the third task in fewer than half the control steps that were required for the first task, even though the tasks are similar in complexity.

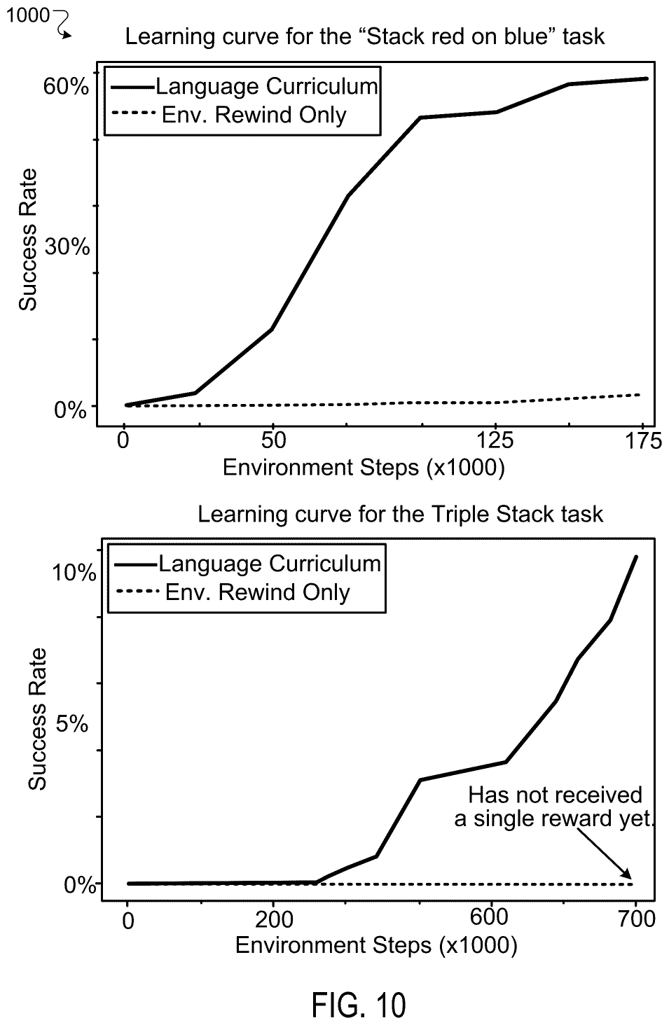

FIG. 10 shows another example 1000 of the performance of the described techniques. In particular, FIG. 10 shows an example of the results of the described technique achieved on two robotic stacking tasks relative to a baseline technique that trains the policy neural network using only environment rewards. As can be seen from FIG. 10, the use of the policy neural network achieves significantly higher success rates than the baseline technique as a result of the higher-quality training data. In fact, for the “triple stack” task, the baseline technique is unable to achieve any success due to the complexity of the task while the described techniques continue to improve as training progresses.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, a Microsoft Cognitive Toolkit framework, an Apache Singa framework, or an Apache MXNet framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what can be claimed, but rather as descriptions of features that can be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features can be described above as acting in certain combinations and even initially be claimed as such, one or more features from a claimed combination can in some cases be excised from the combination, and the claimed combination can be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing can be advantageous.

Aspects of the present disclosure may be as set out in the following clauses:
Clause 1. A method for generating instructions for an agent interacting with an environment to perform a task, the method comprising:
   receiving a natural language description of the task to be performed by the agent;
   processing, using a language model neural network, an input sequence derived from the natural language description of the task to generate an output text sequence that comprises natural language descriptions of each of a sequence of sub-goals to be achieved by the agent while performing the task;
   generating a respective text embedding for each of the sub-goals in the sequence by processing the natural language description of the sub-goal using a vision-language model (VLM) neural network;
   at each of one or more time steps:
      receiving a current observation image characterizing a current state of the environment at the time step;
      identifying a current sub-goal in the sequence of sub-goals being performed by the agent at the time step;
      generating, using the VLM neural network and from the current observation image, an observation embedding of the current observation;
      determining, from the observation embedding of the current observation and the text embedding of the current sub-goal, whether the agent has successfully achieved the current sub-goal in the sequence as of the time step; and
      in response to determining that the agent has successfully achieved the current sub-goal in the sequence as of the time step, instructing the agent to perform a next sub-goal that follows the current sub-goal in the sequence.
Clause 2. The method of clause 1, wherein determining, from the observation embedding of the current observation and the text embedding of the current sub-goal, whether the agent has successfully achieved the current sub-goal in the sequence as of the time step comprises:
   computing a similarity score between the observation embedding of the current observation and the text embedding of the current sub-goal; and
   determining that the agent has successfully achieved the current sub-goal when the similarity score satisfies a threshold.
Clause 3. The method of clause 2, wherein the similarity score is a dot product and the threshold is satisfied when the dot product exceeds the threshold.
Clause 4. The method of clause 2 or clause 3, wherein instructing the agent to perform a next sub-goal that follows the current sub-goal in the sequence comprises:
   determining, from the natural language description of the next sub-goal, one or more actions to be performed by the agent; and
   causing the agent to perform the one or more actions.
Clause 5. The method of clause 4, wherein determining, from the natural language description of the next sub-goal, one or more actions to be performed by the agent comprises:
   processing an input comprising (i) data characterizing the current state of the environment and (ii) data representing the natural language description of the next sub-goal using a language-conditioned policy neural network to generate a policy output that defines an action to be performed by the agent; and
   selecting an action using the policy output.
Clause 6. The method of any preceding clause, wherein the input sequence comprises one or more prompt sequences, each prompt sequence comprising (i) an example natural language task description and (iii) an example output sequence comprising example natural language descriptions of example sub-goals.
Clause 7. The method of clause 6, wherein, within each example output sequence, the example natural language descriptions of example sub-goals are arranged according to a particular syntax, and wherein the method further comprises:
   identifying the natural language descriptions in the output sequence by parsing the output sequence according to the particular syntax.
Clause 8. The method of any preceding clause, wherein the VLM neural network has been pre-trained on a first training data set of images and corresponding text descriptions and fine-tuned on a second training data set that comprises images of the environment and corresponding text descriptions.
Clause 9. The method of any preceding clause, wherein the agent is a mechanical agent and the environment is a real-world environment.
Clause 10. The method of clause 9, wherein the agent is a robot.
Clause 11. The method of any preceding clause, wherein the environment is a real-world environment of a service facility comprising a plurality of items of electronic equipment and the agent is an electronic agent configured to control operation of the service facility.
Clause 12. The method of any preceding clause, wherein the environment is a real-world manufacturing environment for manufacturing a product and the agent comprises an electronic agent configured to control a manufacturing unit or a machine that operates to manufacture the product.
Clause 13. The method of any preceding clause when dependent on clause 5, wherein the environment is a simulation of a real-world environment, wherein the natural language description of the task is received during training of the language-conditioned policy neural network, and wherein the method further comprises:
   after the training, controlling a real-world agent in the real-world environment using the policy neural network.
Clause 14. The method of any preceding clause, when dependent on clause 5, wherein the environment is a simulation of a real-world environment, wherein the natural language description of the task is received during training of the language-conditioned policy neural network, and wherein the method further comprises:
   after the training, providing data specifying the policy neural network for use in controlling a real-world agent in the real-world environment.
Clause 15. The method of any one of clauses 1-8, wherein instructing the agent to perform a next sub-goal that follows the current sub-goal in the sequence comprises:
   providing, to the agent, information about how to perform the task that is generated using at least the description of the next sub-goal.
Clause 16. The method of clause 15, wherein the agent comprises a user of a digital assistant, the method comprising:
   obtaining information defining the task from the digital assistant; and
   using the digital assistant to provide the information about how to perform the task to the user.
Clause 17. The method of clause 16, further comprising receiving, at the digital assistant, a request from the user for assistance;
   determining, in response to the request, that the user should perform the task; and
   outputting, from the digital assistant to the user, an indication of the task to be performed; wherein the current observation is a visual or audio observation or both of the user performing the task captured by the digital assistant.
Clause 18. A method of training a language-conditioned policy neural network that is configured to process an input comprising (i) data characterizing a state of an environment and (ii) data representing a natural language description of a task to generate a policy output that defines an action to be performed by an agent interacting with the environment to perform the task, the method comprising:
   processing, using a language model neural network, an input sequence derived from the natural language description of the task to generate an output text sequence that comprises natural language descriptions of each of a sequence of sub-goals to be achieved by the agent while performing the task;
   controlling the agent using the language-conditioned policy neural network to perform a task episode of the task and to generate a trajectory that includes experience data for each of a sequence of time steps during the task episode that comprises a respective observation image for the time step;
   determining, using a vision-language model (VLM) neural network, whether any of the sub-goals in the sequence were successfully achieved by the agent at any of the sequence of time steps;
   in response to determining that a given sub-goal was achieved at a given time step of the plurality of time steps, adding a trajectory that includes experience data for time steps preceding the given time step in the task episode to a replay memory for use in training the policy neural network.
Clause 19. The method of clause 18, further comprising:
   selecting one or more trajectories from the replay memory; and
   training the policy neural network on the one or more trajectories through imitation learning.
Clause 20. The method of clause 18 or 19, further comprising:
   receiving a reward that indicates whether the task was successfully performed during the task episode; and
   when the reward indicates that the task was successfully performed, adding the trajectory to the replay memory.
Clause 21. The method of any one of clauses 18-20, wherein determining, using a vision-language model (VLM) neural network, whether any of the sub-goals in the sequence were successfully achieved by the agent at any of the plurality of time steps comprises:
   generating a respective text embedding for each of the sub-goals in the sequence by processing the natural language description of the sub-goal using a vision-language model (VLM) neural network, and
   for each time step:
      generating, using the VLM neural network and from the observation image for the time step, an observation embedding of the observation image for the time step; and
      for each sub-goal, determining, from the observation embedding of the observation image for the time step and the text embedding of the sub-goal, whether the agent has successfully achieved the sub-goal as of the time step.
Clause 22. The method of any one of clauses 18-21, further comprising:
   obtaining a plurality of previous task trajectories for a previous task;
   for each previous task trajectory:
      determining, using the VLM neural network, whether any of the sub-goals in the sequence were successfully achieved by the agent at any of the plurality of time steps in the previous task trajectory; and
      in response to determining that a given sub-goal was achieved at a given time step in the previous task trajectory, adding a trajectory that includes experience data for time steps preceding the given time step in the previous task trajectory to the replay memory for use in training the policy neural network.
Clause 23. The method of clause 22, wherein each previous task trajectory was generated while the policy neural network was conditioned on data representing a description of a respective different task.
Clause 24. The method of any preceding clause, wherein the agent is a mechanical agent and the environment is a real-world environment.
Clause 25. The method of clause 24, wherein the agent is a robot.
Clause 26. The method of any preceding clause, wherein the environment is a real-world environment of a service facility comprising a plurality of items of electronic equipment and the agent is an electronic agent configured to control operation of the service facility.
Clause 27. The method of any preceding clause, wherein the environment is a real-world manufacturing environment for manufacturing a product and the agent comprises an electronic agent configured to control a manufacturing unit or a machine that operates to manufacture the product.
Clause 28. The method of any preceding clause, wherein the environment is a simulation of a real-world environment, wherein the natural language description of the task is received during training of the language-conditioned policy neural network, and wherein the method further comprises:
   after the training, controlling a real-world agent in the real-world environment using the policy neural network.
Clause 29. The method of any preceding clause, wherein the environment is a simulation of a real-world environment and wherein the method further comprises:
   after the training, providing data specifying the policy neural network for use in controlling a real-world agent in the real-world environment.
Clause 30. A system comprising:
   one or more computers; and
   one or more storage devices communicatively coupled to the one or more computers, wherein the one or more storage devices store instructions that, when executed by the one or more computers, cause the one or more computers to perform the operations of the respective method of any one of clauses 1-29.
Clause 31. One or more non-transitory computer storage media storing instructions that when executed by one or more computers cause the one or more computers to perform the operations of the respective method of any one of clauses 1-29.

What is claimed is:

1. A method for generating instructions for an agent interacting with an environment to perform a task, the method comprising:
receiving a natural language description of the task to be performed by the agent;
processing, using a language model neural network, an input sequence derived from the natural language description of the task to generate an output text sequence that comprises natural language descriptions of each of a sequence of sub-goals to be achieved by the agent while performing the task;
at each of one or more time steps:
receiving a current observation image characterizing a current state of the environment at the time step;
identifying a current sub-goal in the sequence of sub-goals being performed by the agent at the time step;
generating, using a vision-language model (VLM) neural network and from the current observation image, an observation embedding of the current observation;
determining whether the agent has successfully achieved the current sub-goal in the sequence as of the time step; and
in response to determining that the agent has successfully achieved the current sub-goal in the sequence as of the time step, instructing the agent to perform a next sub-goal that follows the current sub-goal in the sequence.

2. The method of claim 1, wherein instructing the agent to perform a next sub-goal that follows the current sub-goal in the sequence comprises:
determining, from the natural language description of the next sub-goal, one or more actions to be performed by the agent; and
causing the agent to perform the one or more actions.

3. The method of claim 2, wherein determining, from the natural language description of the next sub-goal, one or more actions to be performed by the agent comprises:
processing an input comprising (i) data characterizing the current state of the environment and (ii) data representing the natural language description of the next sub-goal using a language-conditioned policy neural network to generate a policy output that defines an action to be performed by the agent; and
selecting an action using the policy output.

4. The method of claim 1, wherein the input sequence comprises one or more prompt sequences, each prompt sequence comprising (i) an example natural language task description and (iii) an example output sequence comprising example natural language descriptions of example sub-goals.

5. The method of claim 4, wherein, within each example output sequence, the example natural language descriptions of example sub-goals are arranged according to a particular syntax, and wherein the method further comprises:
identifying the natural language descriptions in the output sequence by parsing the output sequence according to the particular syntax.

6. The method of claim 1, wherein the VLM neural network has been pre-trained on a first training data set of images and corresponding text descriptions and fine-tuned on a second training data set that comprises images of the environment and corresponding text descriptions.

7. The method of claim 1, wherein the agent is a mechanical agent and the environment is a real-world environment.

8. The method of claim 7, wherein the agent is a robot.

9. The method of claim 1, wherein the environment is a real-world environment of a service facility comprising a plurality of items of electronic equipment and the agent is an electronic agent configured to control operation of the service facility.

10. The method of claim 1, wherein the environment is a real-world manufacturing environment for manufacturing a product and the agent comprises an electronic agent configured to control a manufacturing unit or a machine that operates to manufacture the product.

11. The method of claim 3, wherein the environment is a simulation of a real-world environment, wherein the natural language description of the task is received during training of the language-conditioned policy neural network, and wherein the method further comprises:
after the training, controlling a real-world agent in the real-world environment using the policy neural network.

12. The method of claim 3, wherein the environment is a simulation of a real-world environment, wherein the natural language description of the task is received during training of the language-conditioned policy neural network, and wherein the method further comprises:
after the training, providing data specifying the policy neural network for use in controlling a real-world agent in the real-world environment.

13. The method of claim 1, wherein determining whether the agent has successfully achieved the current sub-goal in the sequence as of the time step comprises:
determining, from the observation embedding of the current observation, whether the agent has successfully achieved the current sub-goal in the sequence as of the time step.

14. The method of claim 13, further comprising:
generating a respective text embedding for each of the sub-goals in the sequence by processing the natural language description of the sub-goal using a vision-language model (VLM) neural network, wherein determining whether the agent has successfully achieved the current sub-goal in the sequence as of the time step comprises:
determining, from the observation embedding of the current observation and the text embedding of the current sub-goal, whether the agent has successfully achieved the current sub-goal in the sequence as of the time step.

15. The method of claim 14, wherein determining, from the observation embedding of the current observation and the text embedding of the current sub-goal, whether the agent has successfully achieved the current sub-goal in the sequence as of the time step comprises:
computing a similarity score between the observation embedding of the current observation and the text embedding of the current sub-goal; and
determining that the agent has successfully achieved the current sub-goal when the similarity score satisfies a threshold.

16. The method of claim 15, wherein the similarity score is a dot product and the threshold is satisfied when the dot product exceeds the threshold.

17. The method of claim 1, wherein instructing the agent to perform a next sub-goal that follows the current sub-goal in the sequence comprises:
providing, to the agent, information about how to perform the task that is generated using at least the description of the next sub-goal.

18. The method of claim 17, wherein the agent comprises a user of a digital assistant, the method comprising:
obtaining information defining the task from the digital assistant; and
using the digital assistant to provide the information about how to perform the task to the user.

19. The method of claim 18, further comprising receiving, at the digital assistant, a request from the user for assistance;
determining, in response to the request, that the user should perform the task; and
outputting, from the digital assistant to the user, an indication of the task to be performed;
wherein the current observation is a visual or audio observation or both of the user performing the task captured by the digital assistant.

20. A method of training a language-conditioned policy neural network that is configured to process an input comprising (i) data characterizing a state of an environment and (ii) data representing a natural language description of a task to generate a policy output that defines an action to be performed by an agent interacting with the environment to perform the task, the method comprising:
processing, using a language model neural network, an input sequence derived from the natural language description of the task to generate an output text sequence that comprises natural language descriptions of each of a sequence of sub-goals to be achieved by the agent while performing the task;
controlling the agent using the language-conditioned policy neural network to perform a task episode of the task and to generate a trajectory that includes experience data for each of a sequence of time steps during the task episode that comprises a respective observation image for the time step;
determining, using a vision-language model (VLM) neural network, whether any of the sub-goals in the sequence were successfully achieved by the agent at any of the sequence of time steps; and
in response to determining that a given sub-goal was achieved at a given time step of the plurality of time steps, adding a trajectory that includes experience data for time steps preceding the given time step in the task episode to a replay memory for use in training the policy neural network.

21. The method of claim 20, further comprising:
selecting one or more trajectories from the replay memory; and
training the policy neural network on the one or more trajectories through imitation learning.

22. The method of claim 20, further comprising:
receiving a reward that indicates whether the task was successfully performed during the task episode; and
when the reward indicates that the task was successfully performed, adding the trajectory to the replay memory.

23. The method of claim 20, wherein determining, using a vision-language model (VLM) neural network, whether any of the sub-goals in the sequence were successfully achieved by the agent at any of the plurality of time steps comprises:
generating a respective text embedding for each of the sub-goals in the sequence by processing the natural language description of the sub-goal using a vision-language model (VLM) neural network, and
for each time step:
generating, using the VLM neural network and from the observation image for the time step, an observation embedding of the observation image for the time step; and
for each sub-goal, determining, from the observation embedding of the observation image for the time step and the text embedding of the sub-goal, whether the agent has successfully achieved the sub-goal as of the time step.

24. The method of claim 20, further comprising:
obtaining a plurality of previous task trajectories for a previous task;
for each previous task trajectory:
determining, using the VLM neural network, whether any of the sub-goals in the sequence were successfully achieved by the agent at any of the plurality of time steps in the previous task trajectory; and
in response to determining that a given sub-goal was achieved at a given time step in the previous task trajectory, adding a trajectory that includes experience data for time steps preceding the given time step in the previous task trajectory to the replay memory for use in training the policy neural network.

25. The method of claim 24, wherein each previous task trajectory was generated while the policy neural network was conditioned on data representing a description of a respective different task.

26. The method of claim 20, wherein the agent is a mechanical agent and the environment is a real-world environment.

27. The method of claim 26, wherein the agent is a robot.

28. The method of claim 20, wherein the environment is a simulation of a real-world environment, wherein the method further comprises:
after the training, controlling a real-world agent in the real-world environment using the policy neural network.

29. The method of claim 20, wherein the environment is a simulation of a real-world environment and wherein the method further comprises:
after the training, providing data specifying the policy neural network for use in controlling a real-world agent in the real-world environment.

30. A system comprising:
one or more computers; and
one or more storage devices communicatively coupled to the one or more computers, wherein the one or more storage devices store instructions that, when executed by the one or more computers, cause the one or more computers to perform operations for generating instructions for an agent interacting with an environment to perform a task, the operations comprising:
receiving a natural language description of the task to be performed by the agent;
processing, using a language model neural network, an input sequence derived from the natural language description of the task to generate an output text sequence that comprises natural language descriptions of each of a sequence of sub-goals to be achieved by the agent while performing the task;
at each of one or more time steps:
receiving a current observation image characterizing a current state of the environment at the time step;
identifying a current sub-goal in the sequence of sub-goals being performed by the agent at the time step;
generating, using a vision-language model (VLM) neural network and from the current observation image, an observation embedding of the current observation;
determining whether the agent has successfully achieved the current sub-goal in the sequence as of the time step; and
in response to determining that the agent has successfully achieved the current sub-goal in the sequence as of the time step, instructing the agent to perform a next sub-goal that follows the current sub-goal in the sequence.
